(19) United States
(12) Patent Application Publication
(10) Pub. No.: US 2020/0109899 A1
(43) Pub. Date: Apr. 9, 2020

(54) HEAT TRANSPORT DEVICE AND PROJECTION IMAGE DISPLAY DEVICE

(71) Applicant: MAXELL, LTD., Kyoto (JP)

(72) Inventors: Kentaro SANO, Kyoto (JP); Masatoshi ARAI, Kyoto (JP); Yusuke MATSUMOTO, Kyoto (JP); Hiroshi SHIINA, Kyoto (JP)

(21) Appl. No.: 16/623,792

(22) PCT Filed: May 22, 2018
(86) PCT No.: PCT/JP2018/019699

§ 371 Date: Dec. 18, 2019

(30) Foreign Application Priority Data
Jul. 6, 2017 (JP) 2017-133116

(51) Int. Cl. F28D 15/04; F21V 29/502; F21V 29/52; G03B 21/16

(52) U.S. Cl. CPC F28D 15/04; G03B 21/16; F21V 29/52; F21V 29/502

(57) ABSTRACT

A heat transport device 1 includes a housing 2 with a hollow structure, working fluid 3 sealed in a sealed space of the housing 2, and a porous structure member 4 having a capillary structure disposed in the sealed space, and the housing 2 is configured to be rotatable around a rotation axis P by a motor as a drive source. The housing 2 includes an evaporation part S1 for vaporizing the working fluid 3 by heat from a heating element 5 and a condensation part S2 for condensing vapor to restore it to the working fluid 3, and the evaporation part S1 is provided on an outer side in the radial direction than the condensation part S2 with respect to the rotation axis P.

### TECHNICAL FIELD

The present invention relates to a heat transport device utilizing phase change heat transfer by boiling, evaporation, and condensation, and a projection image display device using such a heat transport device.

### BACKGROUND ART

In the technical field to which the present invention belongs, it is provided a projection image display device configured to convert excitation light emitted from a solid light source into visible light by a phosphor so as to perform light emission efficiently. Patent Literature 1 discloses a configuration in which, a disc-shaped phosphor wheel on which a phosphor is formed is rotated by a drive motor to irradiate excitation light (blue laser light) emitted from an excitation light irradiation device to the phosphor wheel, an thereby fluorescence light with multiple colors (red light and green light) is emitted and used as illumination light.

### CITATION LIST

### Patent Literature

Patent Literature 1: JP 2016-57375 A

### SUMMARY OF INVENTION

### Technical Problem

A phosphor film formed on a phosphor wheel receives excitation light and converts it into fluorescence light of a predetermined wavelength band, and the fluorescence light is output from a surface of the phosphor film, meanwhile, the temperature thereof increases with heat generation during wavelength conversion. Accordingly, if not cooling the phosphor film serving as a heating part, luminous efficacy of the phosphor film is deteriorated. In Patent Literature 1, cooling fans are arranged around the phosphor wheel to cool the phosphor wheel thereby, however, it is difficult to sufficiently cool the heating part of the phosphor wheel which performs a rotating operation by the cooling fans of an air-cooling system.

The present invention has been made in view of the above, and an objective thereof is to improve cooling effect of a heat transport device which performs a rotating operation. Furthermore, another objective of the present invention is to provide a projection image display device capable of suppressing temperature increase of a phosphor wheel.

### Solution to Problem

In order to solve the problem above, the present invention is provided with the configuration as set forth in the claims. For example, the present invention provides a heat transport device comprising a housing with a hollow structure in which working fluid is sealed, the housing including: an evaporation part configured to vaporize the working fluid by heat from a heating element; and a condensation part configured to condense vapor to restore the vapor to the working fluid, wherein the housing is rotatably supported around a rotation axis, and the evaporation part is provided on an outer side in a radial direction than the condensation part with respect to the rotation axis.

### Advantageous Effects of Invention

According to the present invention, it is possible to improve cooling effect by utilizing centrifugal force of a heat transport device which performs a rotating operation. The purposes, configurations, and advantageous effects of the present invention other than those described above will be clarified in the following description of the embodiments.

### BRIEF DESCRIPTION OF DRAWINGS

FIG. 1 is an external perspective view of a heat transport device according to a first embodiment of the present invention.

FIG. 2 is a cross-sectional view taken along line A-A of FIG. 1.

FIG. 3 is a cross-sectional view of a heat transport device using another porous structure member.

FIG. 4 is a cross-sectional view of a heat transport device using still another porous structure member.

FIG. 5 is an external perspective view of a heat transport device according to a second embodiment of the present invention.

FIG. 6 is a cross-sectional view taken along line B-B of FIG. 5.

FIG. 7 is an external perspective view of a heat transport device according to a third embodiment of the present invention.

FIG. 8 is an enlarged cross-sectional view taken along line C-C of FIG. 7.

FIG. 9 is an exploded perspective view of a heat transport device according to a third embodiment.

FIG. 10 is a plan view of a porous structure member provided in a heat transport device according to the third embodiment.

FIG. 11 is a plan view illustrating a modified example of a porous structure member.

FIGS. 12A and 12B are explanatory diagrams of shape of an opening of provided in a porous structure member illustrated in FIG. 11.

FIG. 13 is a plan view illustrating another modified example of a porous structure member.

FIG. 14 is a plan view illustrating still another modified example of a porous structure member.

FIG. 15 is a perspective view illustrating heat dissipation fins provided in a first case.

FIG. 16 is a perspective view illustrating heat dissipation fins provided in a second case.

FIG. 17 is a perspective view illustrating a blower blade provided in the second case.

FIG. 18 is an explanatory diagram illustrating a functional block of a projector according to the embodiments of the present invention.

FIG. 19 is a schematic diagram of a light source device provided in a projector according to the present embodiment.

FIG. 20 is a schematic diagram of another light source device provided in the projector according to the present embodiment.

### DESCRIPTION OF EMBODIMENTS

Hereinafter, embodiments of the present invention will be described in detail with reference to the drawings. In all the drawings for explaining the embodiments, the same elements are provided with the same reference signs in general, and repetitive explanation therefor will be omitted. On the other hand, there will be a case where an element already described with a reference sign in a certain drawing is referred to by the same reference sign at the time of explaining the other drawings although it is not illustrated therein again.

### <Heat Transport Device>

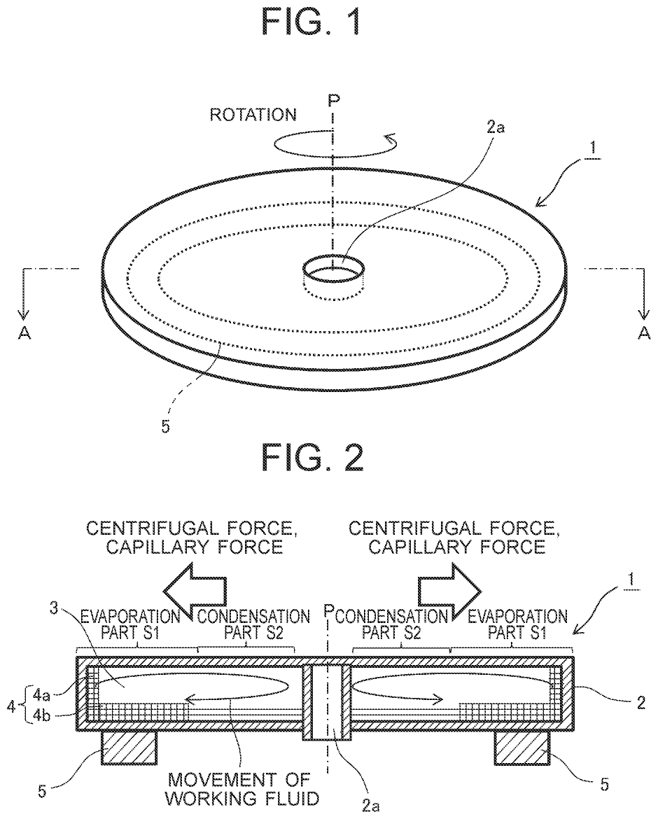

An embodiment of a heat transport device according to the present invention will be described with reference to the drawings. FIG. 1 is an external perspective view of a heat transport device according to a first embodiment, and FIG. 2 is a cross-sectional view taken along a line A-A of FIG. 1.

As illustrated in FIG. 1 and FIG. 2, a heat transport device 1 according to the first embodiment includes a housing 2 with a hollow structure having a sealed space therein, working fluid 3 sealed in the sealed space of the housing 2, and a porous structure member 4 having a capillary structure disposed in the sealed space of the housing 2. The housing 2 is made of a metal material having excellent thermal conductivity such as aluminum or copper, and is formed into disk shape as a whole. A shaft hole 2a is provided at a central portion of the housing 2, and by press-fitting a rotary shaft of a motor (not illustrated) into the shaft hole 2a, the housing 2 can rotate around a rotation axis P by the motor as a drive source. Furthermore, a heating element 5 is attached to an outer surface of the housing 2, which extends annularly along a lower surface of an outer peripheral part of the housing 2.

The porous structure member 4 moves the working fluid 3 by capillary action, and in the present embodiment, the porous structure member 4 is formed to have an L-shape cross section and provided on an outer peripheral side in the sealed space of the housing 2 such that it corresponds to the heating element 5. Here, an area of the outer peripheral side in the housing 2 in which the porous structure member 4 is arranged serves as an evaporation part S1 for vaporizing the working fluid 3 by heat from the heating element 5, while an area of an inner peripheral side in the housing 2 on which the porous structure member 4 is not arranged serves as a condensation part S2 for condensing vapor to restore it to the working fluid 3. That is, the evaporation part S1 is provided on an outer side in the radial direction than the condensation part S2 with respect to the rotation axis P.

In the heat transport device 1 configured as described above, the heat from the heating element 5 is transmitted to the porous structure member 4 via a lower surface of the housing 2, the working fluid 3 included in the porous structure member 4 that has been heated is boiled and evaporated, and the vapor is condensed by the condensation part S2 arranged on the inner peripheral side of the sealed space and then is restored to the working fluid 3. The working fluid 3 liquefied by condensation moves from the condensation part S2 arranged on the inner peripheral side to the evaporation part S1 arranged on the outer peripheral side by centrifugal force due to rotating operation of the housing 2 and by capillary force of the porous structure member 4, and a cycle of evaporation occurring again in the porous structure member 4 and that of condensation occurring in the condensation part S2 are repeated.

As described above, according to the first embodiment, the housing 2 in which the working fluid 3 is sealed is rotatable around the rotation axis P, and the evaporation part S1 for vaporizing the working fluid 3 by the heat from the heating element 5 is provided, with respect to the rotation axis P, on the outer side in the radial direction than the condensation part S2 for condensing the vapor to restore it to the working fluid 3. With this configuration, the working fluid 3 condensed by utilizing the centrifugal force at the time of rotating operation can be circulated, and accordingly, it is possible to realize the heat transport device 1 having high cooling effect.

Furthermore, in the first embodiment, the evaporation part S1 is constituted by the porous structure member 4 having a capillary structure, and the porous structure member 4 includes a vertical section 4a extending vertically and arranged on the outermost periphery in the sealed space of the housing 2, and a horizontal section 4b extending in an inner peripheral direction continuously from one end of the vertical section 4a. Accordingly, it is possible to promote boiling of the working fluid 3 excellently.

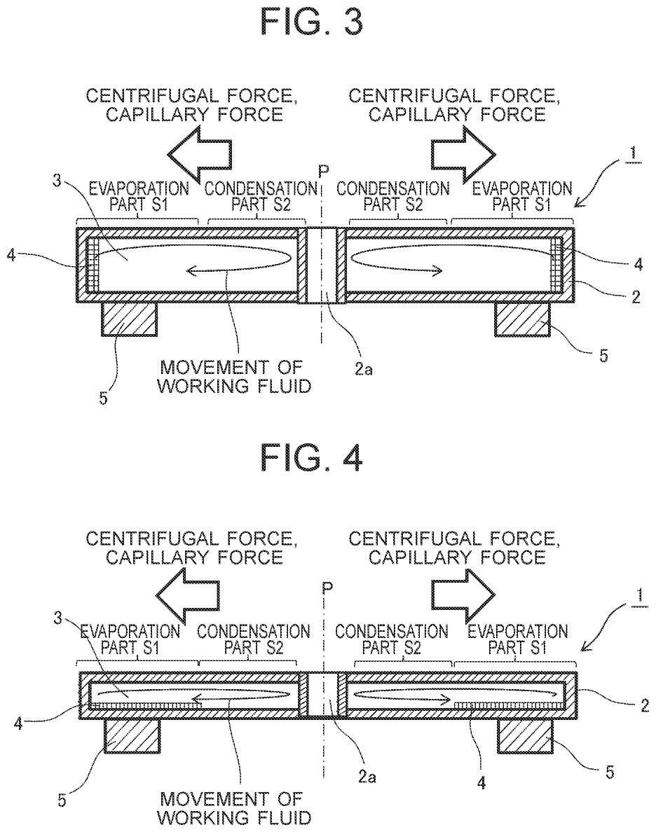

In the first embodiment, an example of the porous structure member 4 in which the vertical section 4a and the horizontal section 4b are arranged continuously to form L-shape is described. On the other hand, the configuration of the porous structure member 4 is not limited to the example above, but may be configured differently, for instance, in accordance with the rotational speed of the heat transport device 1. Such as, in the case of a heat transport device 1 rotating at high speed, as illustrated in FIG. 3, the porous structure member 4 may be configured such that the horizontal section 4b is omitted and only the vertical section 4a is arranged. In the case of a heat transport device 1 rotating at low speed, as illustrated in FIG. 4, the porous structure member 4 may be configured such that the vertical section 4a is omitted and only the horizontal section 4b is arranged.

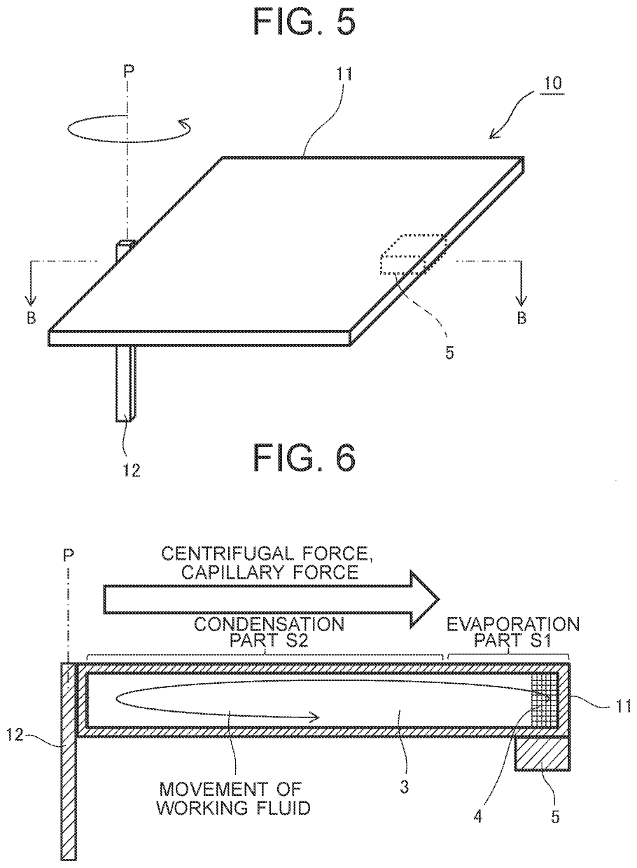

Furthermore, in the first embodiment, an example in which the rotation axis P of the heat transport device is set at the center of the housing is described, on the other hand, as illustrated in FIG. 5 and FIG. 6, the rotation axis P may be set at a position passing through an outer surface of the housing.

FIG. 5 is an external perspective view of a heat transport device 10 according to a second embodiment, and FIG. 6 is a cross-sectional view taken along line B-B of FIG. 5. In the heat transport device 10 according to the second embodiment, a support member 12 fixed to one of the side surfaces of the housing 11 formed in the form of a rectangular flat plate is driven by a motor (not illustrated), and thereby the housing 11 can rotate around the rotation axis P which is along an extension direction of the support member 12. The working fluid 3 is sealed in a sealed space of the housing 11, and a porous structure member 4 having a capillary structure is arranged at an outer peripheral part of the sealed space which is farthest from the support member 12. Furthermore, a heating element 5 is attached to a lower surface of the outer peripheral part of the housing 11 so as to correspond to the porous structure member 4.

In the heat transport device 10 according to the second embodiment as well, an area of an outer peripheral side in the housing 11 in which the porous structure member 4 is arranged serves as an evaporation part S1 for vaporizing the working fluid 3 by heat from the heating element 5 while an area of an inner peripheral side in the housing 11 on which the porous structure member 4 is not arranged serves as a condensation part S2 for condensing vapor to restore it to the working fluid 3. That is, the evaporation part S1 is provided on an outer side in the radial direction than the condensation part S2 with respect to a rotation axis P of the housing 11.

In the heat transport device 10 configured as described above, the heat from the heating element 5 is transmitted to the porous structure member 4 via a lower surface of the housing 11, the working fluid 3 included in the porous structure member 4 that has been heated is boiled and evaporated, and the vapor is condensed by the condensation part S2 arranged on the inner peripheral side of the sealed space and then is restored to the working fluid 3. The working fluid 3 liquefied by condensation moves from the condensation part S2 arranged on the inner peripheral side to the evaporation part S1 arranged on the outer peripheral side by centrifugal force of the housing 11 rotating around the rotation axis P and by capillary force of the porous structure member 4, and a cycle of evaporation occurring again in the porous structure member 4 and that of condensation occurring in the condensation part S2 are repeated.

As described above, in the second embodiment in which the rotation axis P is set to be on a position passing through the outer surface of the housing, in the same manner as in the first embodiment in which the rotation axis P is set at the center of the housing, the working fluid 3 condensed by utilizing the centrifugal force at the time of rotating operation can be circulated, and accordingly, it is possible to realize the heat transport device 10 having high cooling effect. In this connection, in the second embodiment as well, the external shape of the housing 11 is not limited to a square but may be any other shape such as a circle, and moreover, the porous structure member 4 may have another structure having such as an L-shaped cross section.

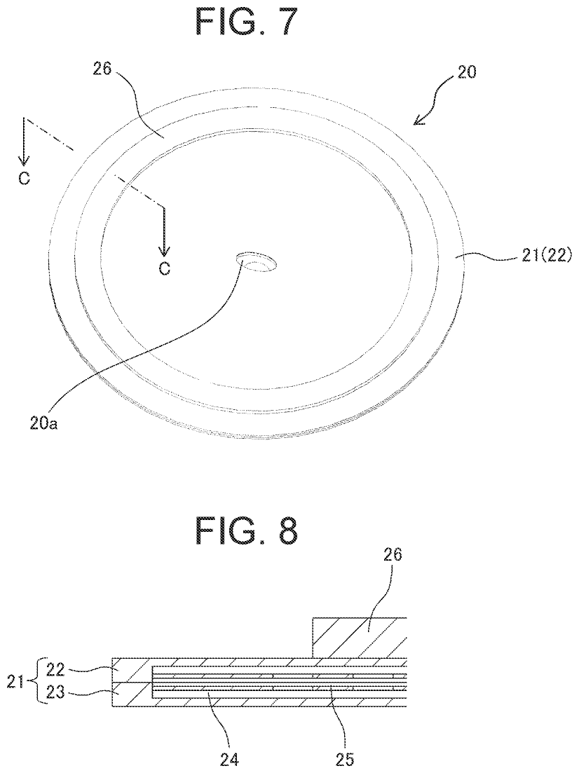

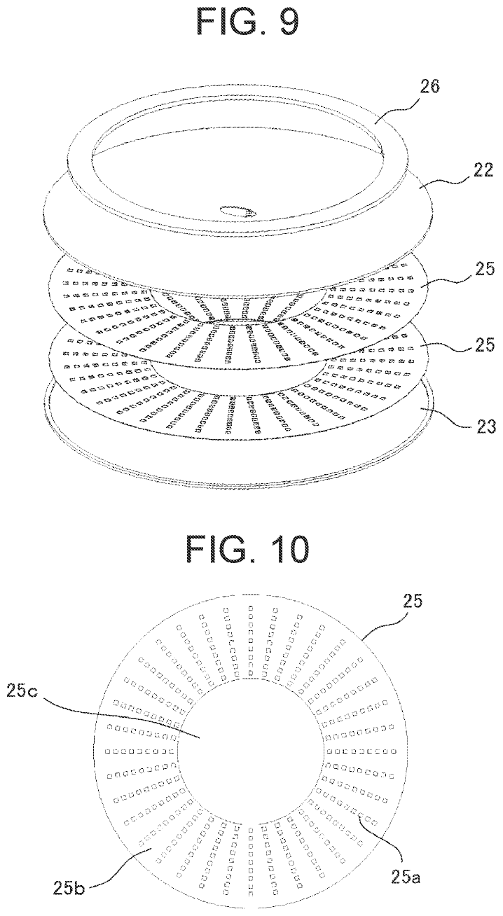

FIG. 7 is an external perspective view of a heat transport device 20 according to the third embodiment, FIG. 8 is an enlarged cross-sectional view taken along line C-C of FIG. 7, and FIG. 9 is an exploded perspective view of the heat transport device 20.

As illustrated in FIGS. 7-9, the heat transport device 20 according to the third embodiment includes a first case 22 and a second case 23 which constitute a housing 21, working fluid 24 sealed in a sealed space within the housing 21, a porous structure member 25 having a capillary structure disposed in the sealed space, and a heating element 26 attached to an upper surface of an outer peripheral part of the first case 22. The first case 22 and the second case 23 are formed into disk shape by using such as aluminum or copper, and joined and integrated with each other, such as by means of welding, to constitute the housing 21 with a hollow structure. A shaft hole 21a is provided at a central portion of the housing 21, and by press-fitting a rotary shaft of a motor (not illustrated) into the shaft hole 21a, the housing 21 can rotate around a rotation axis which passes through the center of the shaft hole 21a.

The porous structure member 25 moves the working fluid 24 by capillary action, and in the present embodiment, the porous structure member 25 made of such as aluminum or copper is adopted. As illustrated in FIG. 10, the porous structure member 25 is formed into ring shape in which a circular opening 25c is provided on an inner side of an annular section 25b, and furthermore, a large number of fine holes 25a are formed on the annular section 25b such as by etching. The outline dimension of the porous structure member 25 is set to be substantially the same as that of the sealed space of the housing 21, and by superposing a plurality of these porous structure members 25 and arranging them on an outer peripheral side of the sealed space, an area of the outer peripheral side in the housing 21 in which the annular section 25b is disposed serves as an evaporation part for vaporizing the working fluid 24 by heat from the heating element 26. Furthermore, an area of an inner peripheral side in the housing 21 which corresponds to the opening 25c of the porous structure member 25 serves as a condensation part for condensing vapor to restore it to the working fluid 24. That is, the evaporation part is provided on an outer side in the radial direction than the condensation part with respect to the rotation axis of the housing 21.

In the heat transport device 20 configured as described above, the heat from the heating element 26 is transmitted to the porous structure member 25 via the first case 22, the working fluid 24 included in the porous structure member 25 that has been heated is boiled and evaporated, and the vapor is condensed by the condensation part arranged on the inner peripheral side of the sealed space and then is restored to the working fluid 24. The working fluid 24 liquefied by condensation moves from the condensation part arranged on the inner peripheral side to the evaporation part arranged on the outer peripheral side by centrifugal force due to rotating operation of the housing 21 and by capillary force of the porous structure member 25, and a cycle of evaporation occurring again in the porous structure member 25 and that of condensation occurring in the condensation part are repeated.

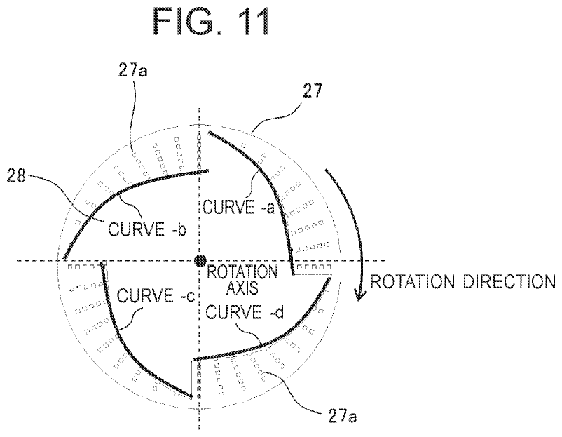

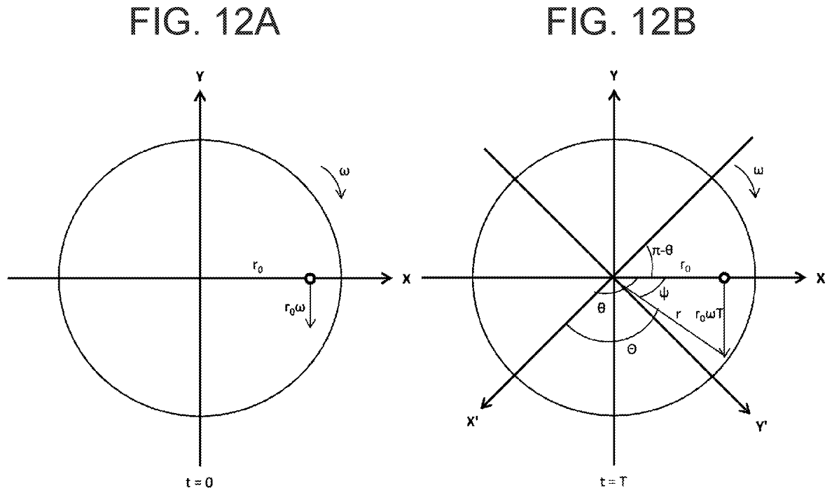

The shape of the porous structure member 25 is not limited to the ring shape described above, and rather it is preferable to be determined in consideration of the rotation speed, etc. of the housing 21. In a modified example illustrated in FIG. 11, a non-circular opening 28 is formed on a porous structure member 27, and a large number of fine holes 27a are formed on an area excluding the opening 28. Here, outer edges of the opening 28 have four curves a to d. In the following, the shape of the opening 28 will be described with reference to FIGS. 12A and 12B.

As illustrated in FIG. 12A, when t=0, it is assumed that a particle is separated at the radial position r0 of the X-Y coordinates with the center of a disk as the origin (the speed of the particle is made constant at r0ω). As illustrated in FIG. 12B, when t=T and viewing from the X′-Y′ coordinate system, the radial direction distance r and relative angle θ of the particle from the rotation axis are obtained as follow.

r=\sqrt{r₀²+(r₀ωT)²}

θ=π−( +π−θ)=θ−Ψ [Formula 1]

Thus, the position of the particle in the X′-Y′ coordinate system is determined as follow.

x=r cos θ

y=r sin θ [Formula 2]

In this way, the following can be obtained from the formula below.

$$\begin{matrix}[ Formula 3 ] & \\ \begin{matrix}x = \sqrt{{r}_{0}^{2} + {( {r}_{0} ω t )}^{2}} cos ( θ - Ψ ) \\ y = \sqrt{{r}_{0}^{2} + {( {r}_{0} ω t )}^{2}} sin ( θ - Ψ )\end{matrix} \} & ( 1 )\end{matrix}$$

The curve-a of the opening 28 can be formed in accordance with the formula (1), and the remaining curves b to d can be formed by moving the curve-a point-symmetrically about the rotation axis.

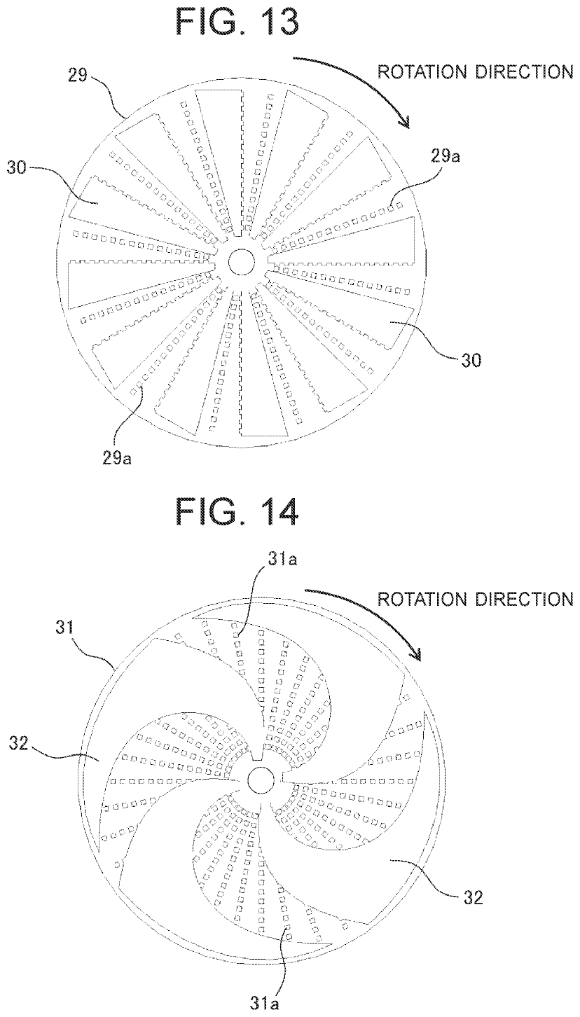

In a modified example illustrated in FIG. 13, a porous structure member 29 is provided with a plurality of triangle openings 30 extending along a rotation direction of the porous structure member 29 and expanding outwardly in the radial direction from an inner diameter side as a vertex, and a large number of fine holes 29a are formed thereon but not on an area where the openings 30 are provided. The expanding angle of each openings 30 can be determined in accordance with the rotation speed of the housing 21, and the porous structure member 29 including these openings 30 as described above is suitably applicable to a heat transport device rotating at relatively low speed.

In a modified example illustrated in FIG. 14, a porous structure member 31 is provided with a plurality of curved openings 32 extending along a rotation direction and expanding outwardly in the radial direction from an inner diameter side as a vertex, and a large number of fine holes 31a are formed thereon but no on an area where the openings 32 are provided. The porous structure member 29 including these curved openings 32 as described above is suitably applicable to a heat transport device rotating at relatively high speed.

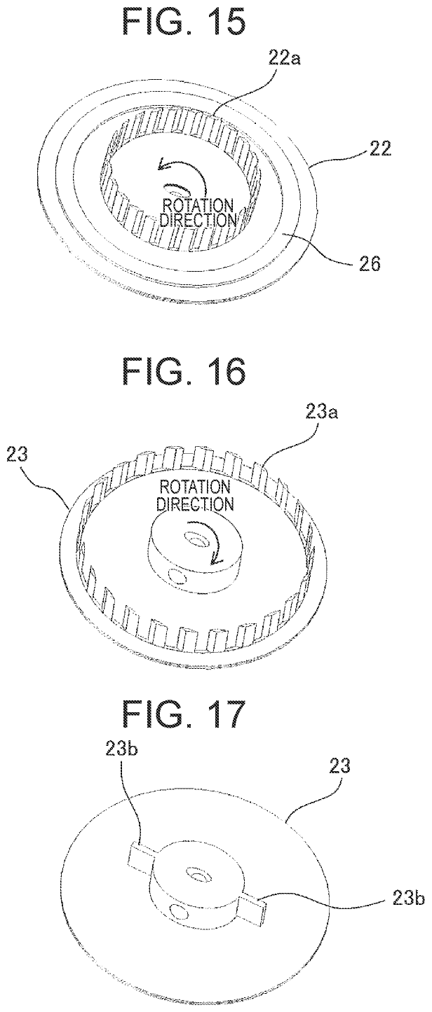

In the heat transport device 20 according to the third embodiment, the first case 22 and the second case 23 which constitute the housing 21 have flat surfaces, on the other hand, as illustrated in FIG. 15, heat dissipation fins 22a may be provided on the surface of the first case 22 to enhance cooling effect. The heat dissipation fins 22a respectively have inclined comb-shape, which enables to blow out the air going up by heat of the first case 22 to the outer diameter side by centrifugal force. The shape of the heat dissipation fins 22a is not limited to the inclined comb-shape, but may have cylindrical or non-inclined comb-shape.

Furthermore, as illustrated in FIG. 16, similar heat dissipation fins 23a may be provided on the surface of the second case 23, or as illustrated in FIG. 17, a blower blade 23b extending outwardly in the radial direction may be provided at a central portion of the second case 23 to enhance the cooling effect. Still further, although not illustrated, fine irregularities may be formed on the surfaces of the first case 22 and the second case 23 to promote heat dissipation thereby.

In this connection, in each of the embodiments above, at least a part of a central portion of the housing serving as a condensation part may be formed of a material having thermal conductivity smaller than that of the other parts. Specifically, when a large part of the housing is formed of a material such as aluminum or copper having high thermal conductivity and at least a part of the central portion of the housing serving as the condensation part is formed of a material such as stainless steel having thermal conductivity lower than that of aluminum or copper, vapor can be condensed and restored to the working fluid efficiently.

### <Projection Image Display Device>

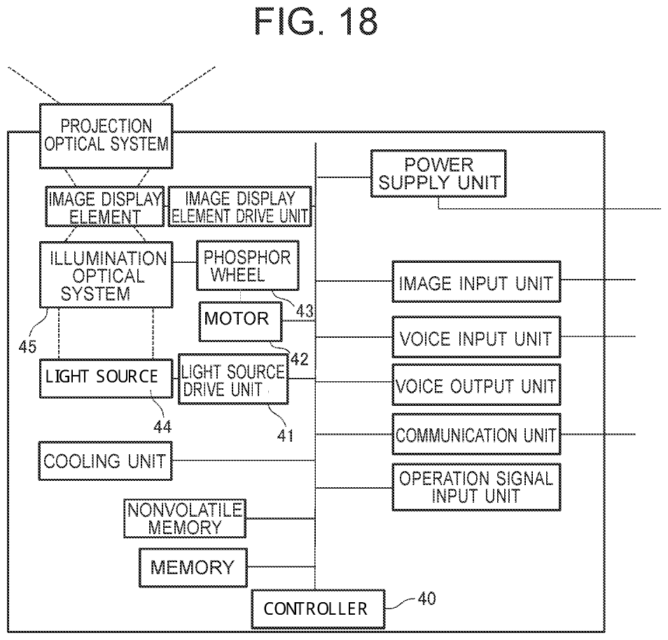

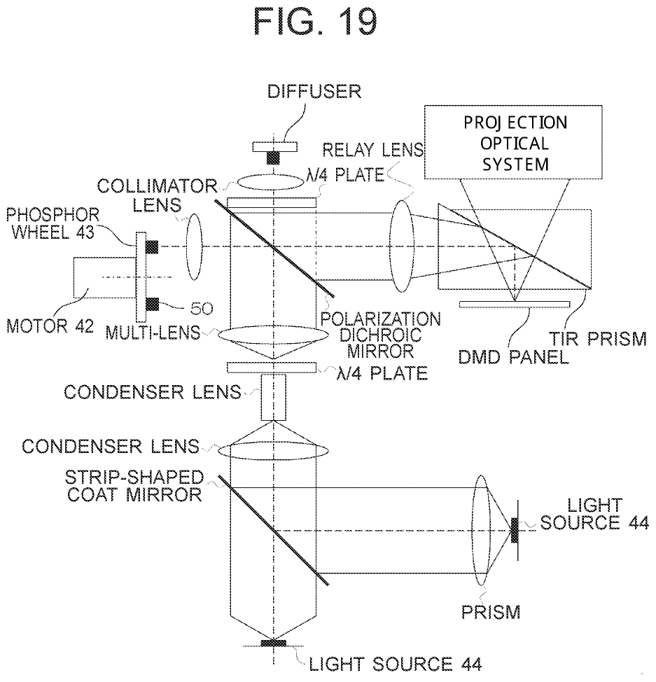

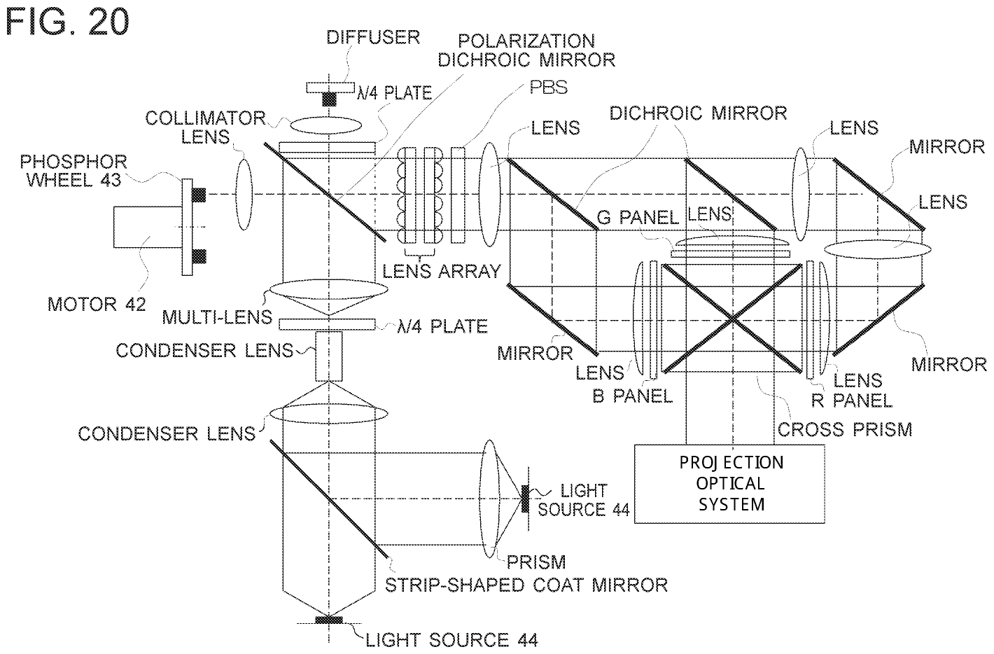

Next, an embodiment of a projection image display device according to the present invention will be described by showing a projector as an example. FIG. 18 is an explanatory diagram illustrating a functional block of a projector according to the present embodiment, FIG. 19 is a schematic diagram of a light source device provided in a DMD projector according to the present embodiment, and FIG. 20 is a schematic diagram of a light source device provided in a LCD projector according to the present embodiment.

As illustrated in FIG. 18, the projector includes a controller 40, a light source drive unit 41, a motor 42, a phosphor wheel 43, light sources 44, an illumination optical system 45, etc. The controller 40 controls the light source drive unit 41, and the light source drive unit 41 separately performs control of light emission of wavelength bands from the light sources 44 such that light of a predetermined wavelength band which is requested at the time of image generation is emitted from the light sources 44. The emitting light from the light sources 44 enters the illumination optical system 45, and finally is enlarged by a projection optical system and projected onto a screen (not illustrated).

The phosphor wheel 43 is one of the components of the illumination optical system 45 and is rotated by the motor 42 as a drive source. The motor 42 may be configured to rotate the phosphor wheel 43 at constant speed, on the other hand, in the present embodiment, a temperature sensor (not illustrated) detects the temperature of the phosphor wheel 43 and the controller 40 controls the rotation speed of the motor 42 from a result of the temperature detection.

In the following, the configuration of a light source device including the illumination optical system 45 will be described. As illustrated in FIG. 19, in this light source device, irradiation light emitted from the light sources 44 (for example, blue laser light) respectively arranged at different positions is converted into luminous flux by corresponding condenser lenses. A part of the luminous flux passes through a polarization dichroic mirror and enters a diffuser, and then blue illuminating luminous flux is generated. The remaining part thereof is reflected by the polarization dichroic mirror and made incident on a phosphor film 50 applied on the phosphor wheel 43, and then yellow illuminating luminous flux is generated. Finally, the former blue illuminating luminous flux and the latter yellow illuminating luminous flux are combined to generate white illuminating luminous flux.

The white illuminating luminous flux is condensed by a relay lens and made incident on a TIR prism, totally reflected therein, and irradiated on a DMD panel in which an image to be projected is generated. The light reflected by the DMD panel passes through the TIR prism, enters the projection optical system and is enlarged thereby, and then the image is projected on a screen, etc. (not illustrated).

Furthermore, as illustrated in FIG. 20, in a light source device provided in an LCD projector, fluorescence light entering a polarization dichroic mirror from the phosphor wheel 43 passes through the polarization dichroic mirror, and is combined with blue illuminating luminous flux generated by a diffuser. The directions of polarization of the combined white illuminating luminous flux are aligned through a lens array, a PBS, and a lens and then condensed. Thereafter, the white illuminating luminous flux is decomposed into blue, green, and red illuminating luminous flux by a dichroic mirror, respectively transmitted through panels, combined again by a cross prism, and then projected by a projection lens.

Here, in the light source devices illustrated in FIG. 19 and FIG. 20, the phosphor film 50 formed on the phosphor wheel 43 receives excitation light emitted from an excitation light source, converts it into fluorescence light of a predetermined wavelength band, and outputs the fluorescence light from a surface of the phosphor film 50, and accordingly, the temperature increases with heat generation during wavelength conversion. The present embodiment applies the heat transport device according to the above-described embodiments to the phosphor wheel 43 to cool the phosphor film 50 serving as a heating part.

That is, as an outer shell of the phosphor wheel 43, the housing 2 with a hollow structure as illustrated in FIG. 1 is adopted, and working fluid 3 is sealed in a sealed space of the housing 2 as well as the porous structure member 4 having a capillary structure is disposed in the sealed space of the housing 2. The phosphor film 50 serving as a heating part may be formed directly on the housing 2, on the other hand, it is possible to form the phosphor film 50 on a substrate different from the housing 2 and integrate the substrate with the housing 2. Furthermore, in accordance with the rotation speed of the phosphor wheel 43, the arrangement structure of the porous structure member 4 as illustrated in FIGS. 2 to 4 or the porous structure members 25, 27, 29, and 31 as illustrated in FIGS. 10 to 14 can be adopted.

As described above, in the projector (projection image display device) of the present embodiment, the phosphor wheel 43 emitting fluorescence light of a predetermined wavelength band upon receiving excitation light from the excitation light source is configured to be the heat transport device according to the first to third embodiments, that is, configured such that the evaporation part is provided on the outer side in the radial direction than the condensation part with respect to the rotation axis of the housing. With this configuration, the working fluid is circulated in the sealed space by utilizing centrifugal force of the phosphor wheel 43 performing a rotating operation, which makes it possible to enhance the cooling effect of the phosphor wheel 43 remarkably as compared to the cooling effect obtained by a cooling fan of an air-cooling system. Furthermore, the working fluid circulates in the sealed space of the housing by utilizing the centrifugal force, and therefore, it is possible to reduce the thickness and weight of the phosphor wheel 43 while maintaining the high cooling effect.

The present invention is not limited to the above-described embodiments, and rather includes various modifications. For example, the embodiments above are described in detail in order to facilitate understanding of the present invention, but not intended to be limited to the ones having all the configurations described above.

### REFERENCE SIGNS LIST

1, 10, 20 heat transport device
2, 11, 21 housing
2a, 21a shaft hole
3, 24 working fluid
4, 25, 27, 29, 31 porous structure member (capillary structure)
4a vertical section
4b horizontal section
5, 26 heating element
12 support member
22 first case
22a heat dissipation fin
23 second case
23a heat dissipation fin
23b blower blade
28, 30, 32 opening
25a, 27a, 29a, 31a fine hole
40 controller
41 light source drive unit
42 motor
43 phosphor wheel
44 light source
45 illumination optical system
50 phosphor film (heating part)
P rotation axis
S1 evaporation part
S2 condensation part

1. A heat transport device comprising a housing with a hollow structure in which working fluid is sealed,
the housing including:
an evaporation part configured to vaporize the working fluid by heat from a heating part; and
a condensation part configured to condense vapor to restore the vapor to the working fluid,
wherein
the housing is rotatably supported around a rotation axis, and
the evaporation part is provided on an outer side in a radial direction than the condensation part with respect to the rotation axis.

2. The heat transport device according to claim 1, wherein
the rotation axis is set to be on a position passing through a center of the housing.

3. The heat transport device according to claim 1, wherein
the rotation axis is set to be on a position passing through an outer surface of the housing.

4. The heat transport device according to claim 1, wherein
the housing includes a capillary structure in an inside of the housing, and
the capillary structure is provided on an outer side in the radial direction than the condensation part with respect to the rotation axis.

5. The heat transport device according to claim 4, wherein
another capillary structure is provided on an inner side in the radial direction than the evaporation part with respect to the rotation axis.

6. The heat transport device according to claim 4, wherein
the capillary structure is formed of a porous structure member having a large number of holes, and
a part of or whole porous structure member serves as the evaporation part.

7. The heat transport device according to claim 6, wherein
the porous structure member is formed into ring shape so as to surround the condensation part.

8. The heat transport device according to claim 6, wherein
the porous structure member is one of a plurality of the porous structure members, and
the plurality of porous structure members are arranged in a laminated state on an outermost section in the radial direction with respect to the rotation axis.

9. The heat transport device according to claim 6, wherein
the porous structure member comprises an opening which expands outwardly in the radial direction from an inner diameter side as a vertex.

10. The heat transport device according to claim 9, wherein
the opening has curved outer edges.

11. The heat transport device according to claim 1, wherein
the housing comprises a first case and a second case which are integrated with each other via a hollow portion, and
heat dissipation fins are provided on either one of or both of a surface of the first case and that of the second case.

12. The heat transport device according to claim 1, wherein
at least a part of the condensation part is formed of a material having thermal conductivity smaller than that of the other parts.

13. A projection image display device comprising:
a light source that emits excitation light;
a phosphor wheel that includes a phosphor film for emitting fluorescence light of a predetermined wavelength band upon receiving the excitation light; and
a drive motor that rotates the phosphor wheel, wherein
the phosphor wheel includes the heat transport device according to claim 1.
